(19) United States
(12) Patent Application Publication
(10) Pub. No.: US 2007/0205981 A1
(43) Pub. Date: Sep. 6, 2007

(54) Media device having alternatively accessible sides

(76) Inventor: William Jefferson Stone III, Santa Cruz, CA (US)

Correspondence Address: WHITE & CASE LLP;PATENT DEPARTMENT, 1155 AVENUE OF THE AMERICAS, NEW YORK, NY, 10036, US

(21) Appl. No.: 11/368,880

(22) Filed: Mar. 5, 2006

(51) Int. Cl. G09G 5/00

(52) U.S. Cl. 345/156

(57) ABSTRACT

This application discloses a media device including a reversible video screen. A case is connected to a reversible unit via an arm and a guide. The arm and guide direct the movement of the video screen such that it rotates 180 degrees within the case. In a first orientation, the screen is viewable through an opening in the case. In a second orientation, the screen is presented full-size, with the controls of the media device still being operational.

### FIELD OF THE INVENTION

The present invention relates generally to media devices. More particularly, the present invention relates to a media device with a reversible screen.

### BACKGROUND

Media devices, especially those in a portable format, are very popular today. The Apple iPod has sold over 42 million units. Other examples of portable media devices include the Sony Playstation Portable (“PSP”), the Nokia N-Gage, the Nintendo Game Boy, personal digital assistants (“PDAs”), and portable DVD players manufactured by many different companies.

One problem the above mentioned devices have in common is that they are only usable in one orientation. Another problem is that the screen sizes of various of the above-described devices is not ideal for playback of video and they do not use all of the available space. For example, the Apple iPod is approximately 104 mm by 61 mm. However, the screen size is only approximately 63.5 mm, as measured by the diagonal. The Sony PSP has a 109 mm diagonal screen size despite the entire device being approximately 170 mm by 74 mm.

The reason for the small screen size is because the manufacturers must provide enough room for the various controls for the media device.

A portable DVD player has much more screen size available, because they generally place the controls on a different portion of the device. However, they generally must be used in an open position, relinquishing some of the utility of a portable device.

It is desirable to have an apparatus the above problems and allow the use of larger screens on portable media devices.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1A-1D are diagrams illustrating a front view of a media device of the present invention;

FIG. 2A-2F are diagrams illustrating a back view of a media device of the present invention; and

FIG. 3A-3I are diagrams illustrating an assembly of the present invention.

### DETAILED DESCRIPTION

In the following description, for purposes of explanation, numerous specific details are set forth to provide a thorough understanding of the present invention. However, it will be apparent to one skilled in the art that these specific details may not be required to practice the present invention.

In the following description of the embodiments, substantially the same parts are denoted by the same reference numerals. Also, while references such as top, bottom and side may be used throughout the specification, it is to be understood that their orientation requirements are only to facilitate the explanation of the various embodiments and depending on the application, the top could be the side or bottom or vice versa.

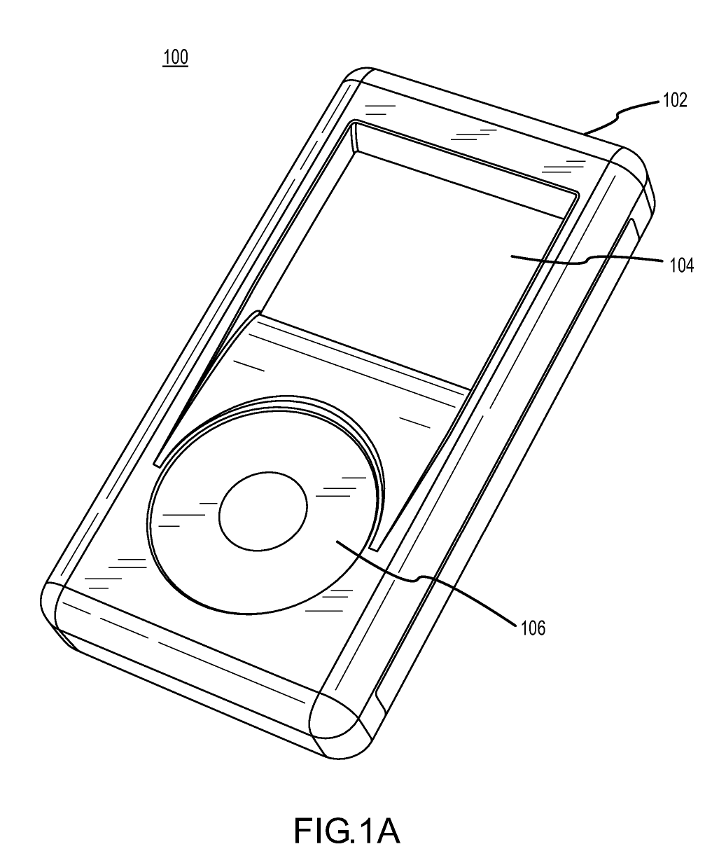

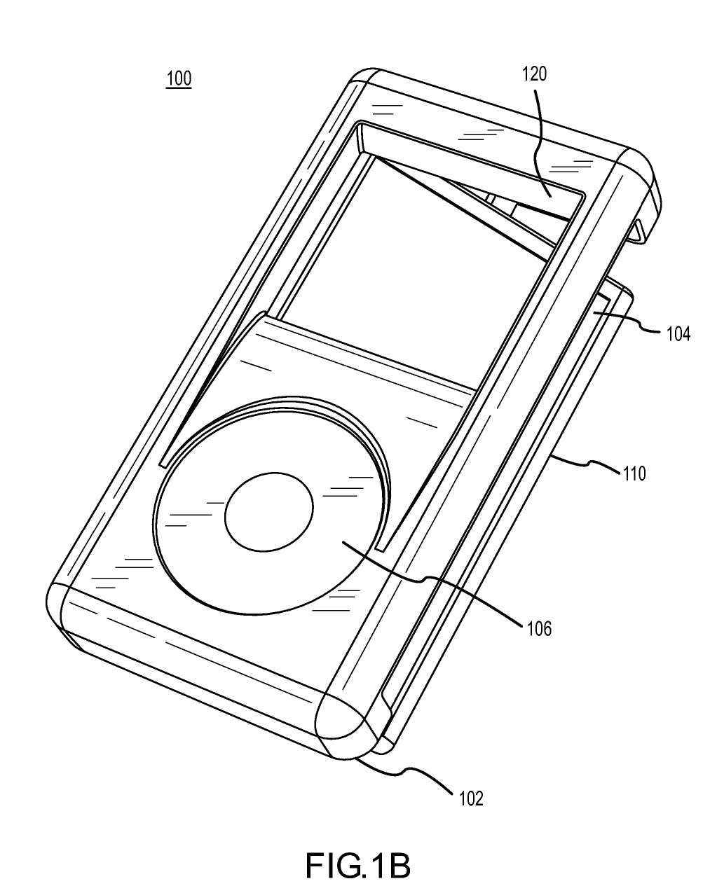

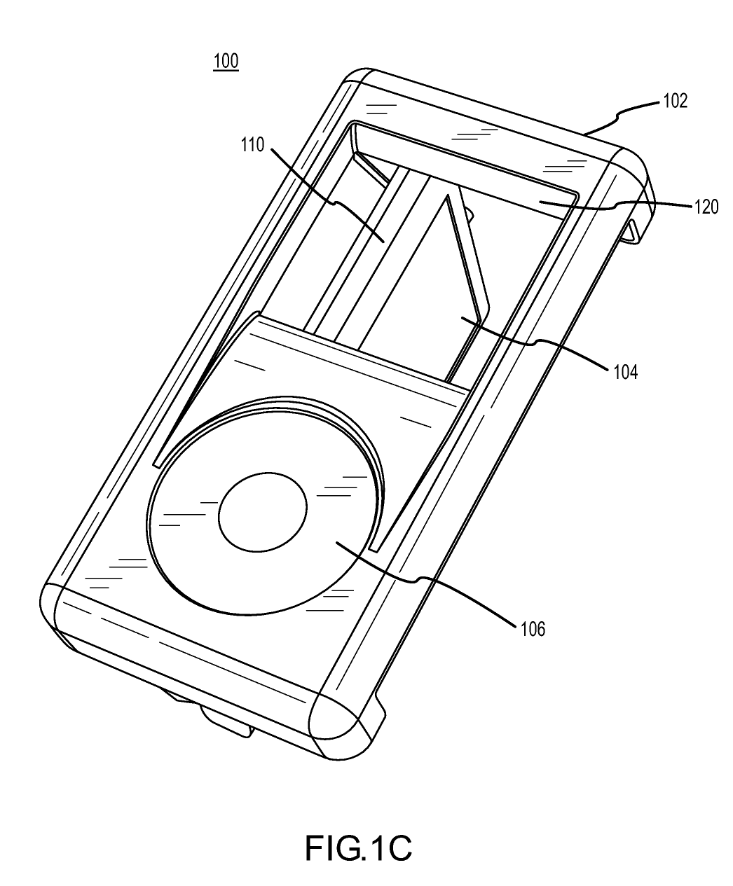

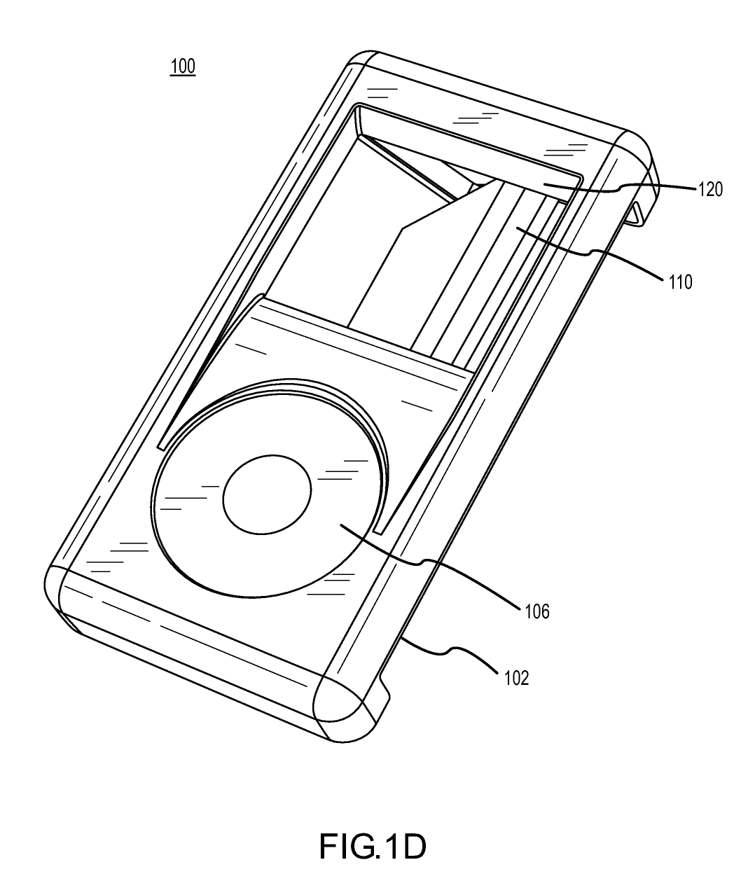

With reference to FIG. 1A, a front view of an embodiment of the present invention is shown. Media device 100 comprises a case 102, screen 104, and input device 106. In typical use, media device 100 may be used to process music or movie files (such as those in the MP3 format) and transmit the music files to a transducer, such as a pair of headphones. The files may be transmitted via a headphone jack or other audio output jack that is now known or may be developed in the future. To control which files are being processed and played back, a user utilizes input device 106. Input device 106 may be a click wheel (as shown), a jog/shuttle dial, a joypad, a set of buttons, a touch-screen, or any device now known or may be developed in the future to input data into a media device. Screen 104 may be used for a variety of different tasks. For example, screen 104 may be used to display photos or video images. Alternatively, screen 104 may be used to display a series of menus, with which a user is able to select a media file to playback.

While FIG. 1A shows a device that bears a similarity to media devices currently available in the marketplace, the present invention contains a significant new feature. As shown in FIGS. 1B-1D, screen 104 is part of a reversible unit 110. Reversible unit 110 is configured to rotate 180 degrees from the position shown in FIG. 1A such that screen 104 is viewable in an alternate manner.

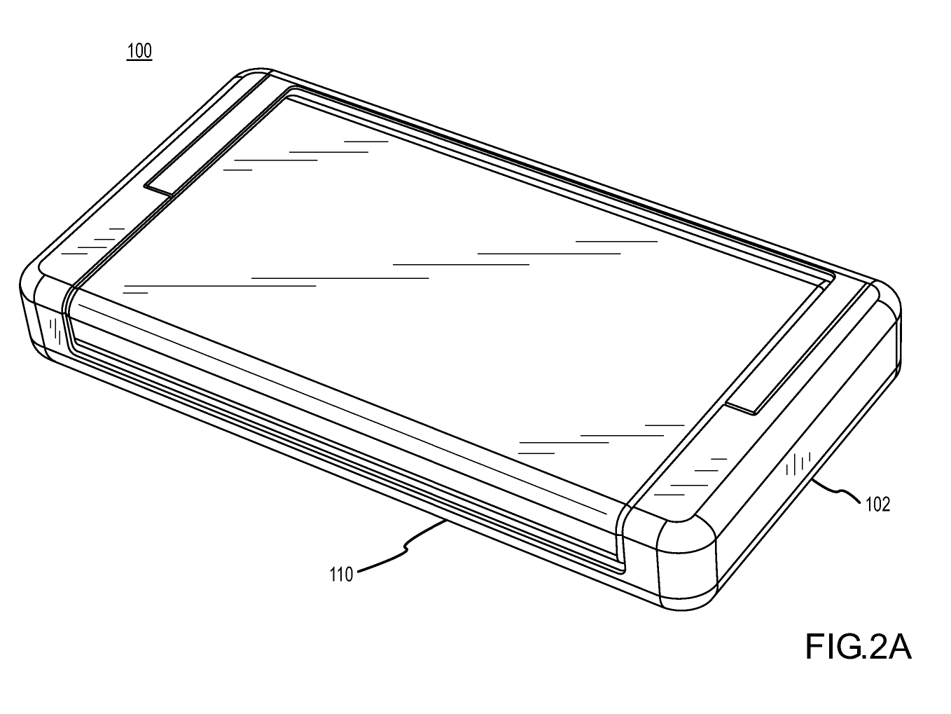

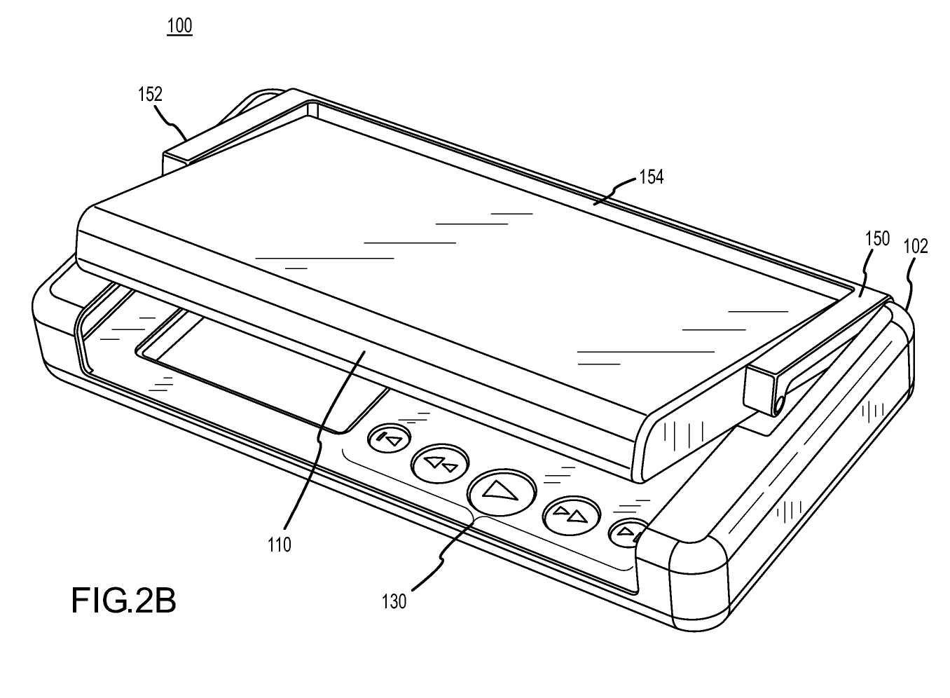

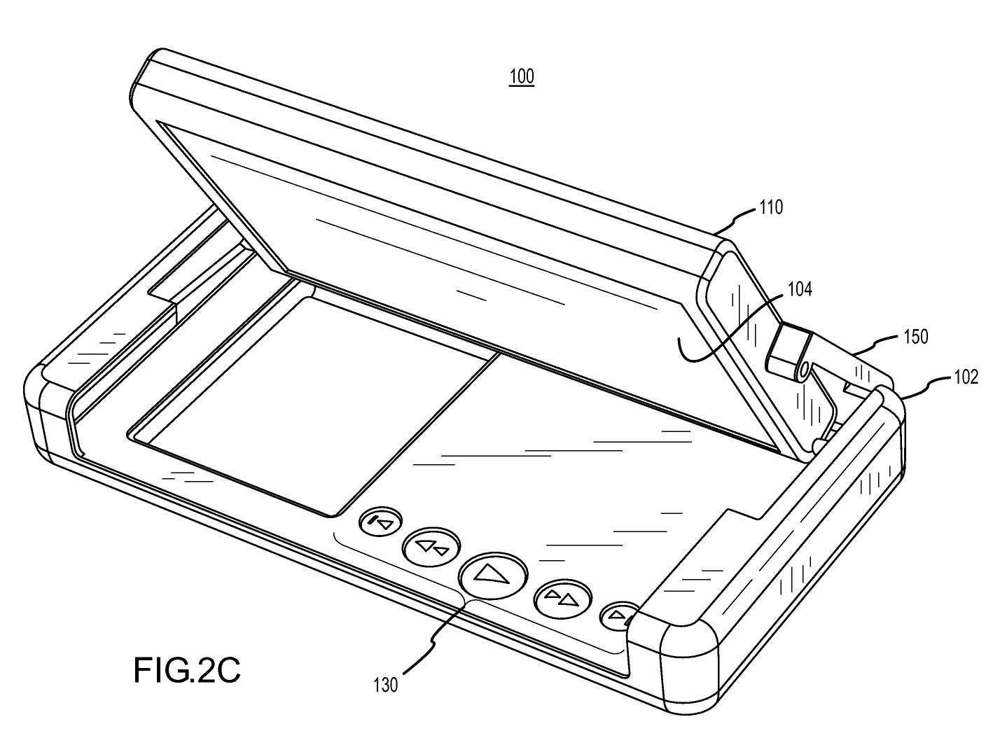

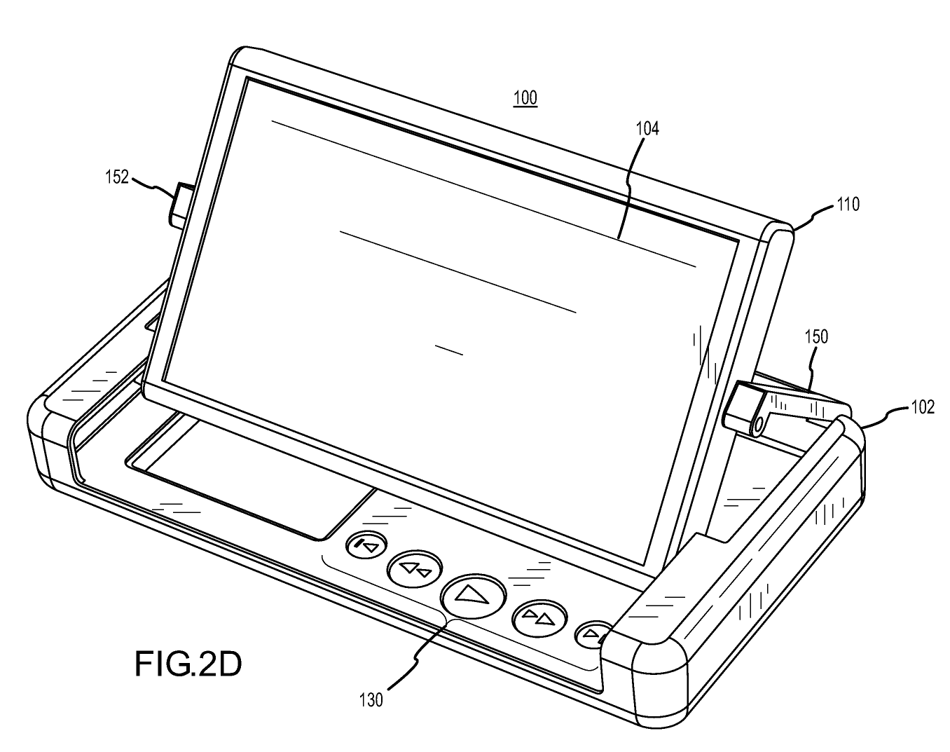

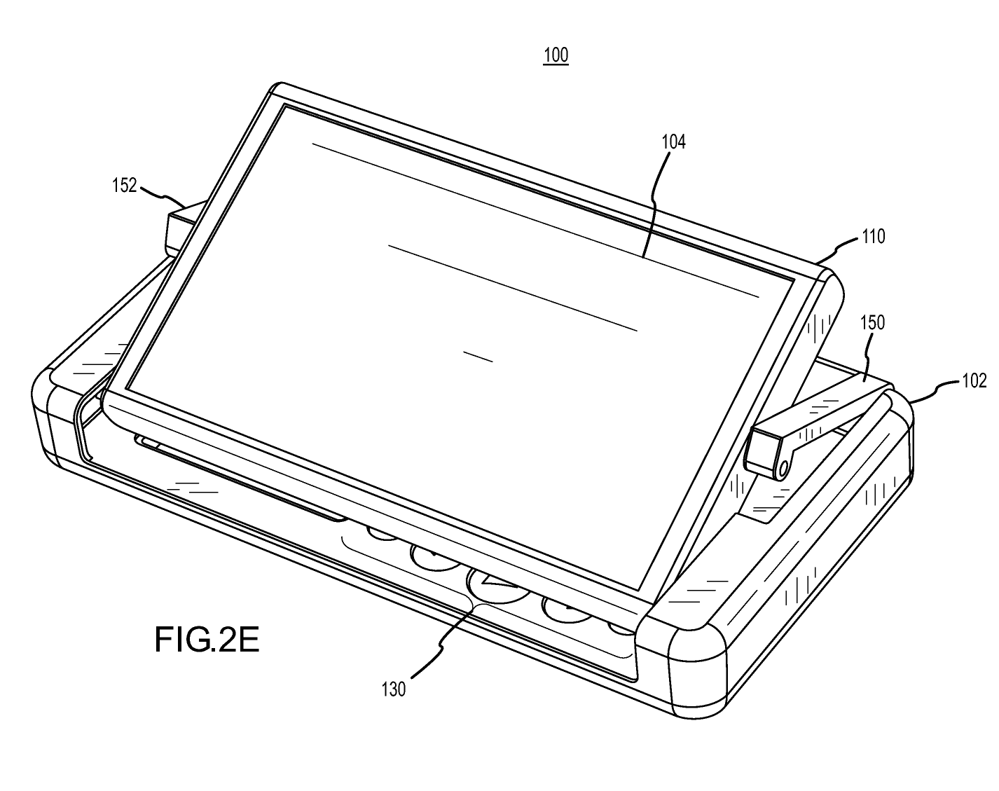

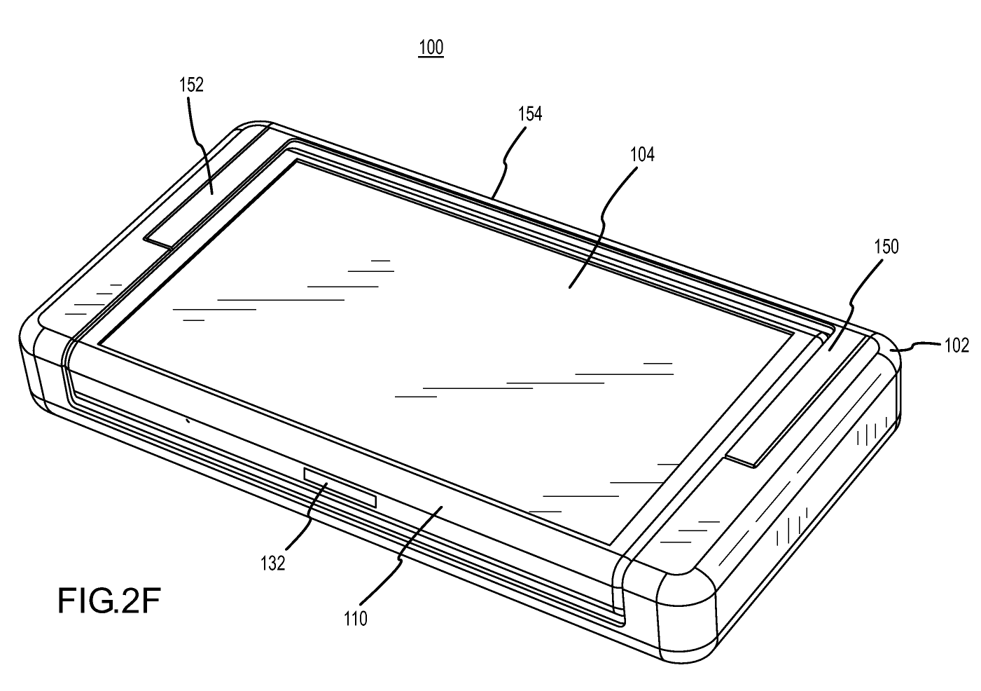

FIGS. 2A-2F show the back view of media device 100 as reversible unit 110 undergoes a reversing process. FIG. 2A shows media device 100 in the orientation as shown in FIG. 1A (hereinafter referred to as the “first orientation”). FIGS. 2B through 2E show media device 100 as reversible unit 110 is rotated from the first orientation to another orientation (hereinafter referred to as the “second orientation”) shown in FIG. 2F. As seen in FIG. 2F, the second orientation allows the viewing of the entirety of screen 104. Reversible unit 110 is rotated 180 degrees from the first orientation compared to the second orientation. As can be seen in these Figures, case 102 is recessed, such that reversible unit 110 is flush with case 102 in both the first orientation and the second orientation.

As best seen in FIGS. 1B-1D, case 102 has an opening 120. In the first orientation, screen 104 is viewable through opening 120. In one embodiment of the present invention, the data being displayed on screen 104 is re-sized, depending on the orientation of the reversible unit 110. In the second orientation, the data being displayed on screen 104 occupies the entirety of screen 104. Thus, such an orientation is well-suited for showing video images or still images at a large size. In the first orientation, the data being displayed on screen 104 is re-sized such that only the area of screen 104 that is visible is being used. Such an orientation may be suited to show information about the media being played or in other situations where a large screen size is not needed. The resizing of the data on screen 104 may be accomplished in any of the methods now known or developed in the future related to the resizing of screens.

There may be a sensor that determines the orientation of reversible unit 110. If reversible unit 110 is in the first orientation, only a portion of screen 104 will be used. If reversible unit 110 is in a different orientation (such as the orientations shown in FIGS. 2D-2F), the entirety (or any desired portion thereof) of screen 104 will be used. The sensor may be any type of sensor now known or developed in the future that is capable of determining if an object is in a certain position. For example, the sensor may be a switch to the side of screen 104. Such a switch may be engaged when reversible unit 110 is in the position shown in FIG. 1A.

FIGS. 1A-1D show opening 120 as a physical opening. In other words, a user is able to place an object through opening 120. That feature may be desirable in certain situation. For example, reversible unit 110 may be configured such that a user's finger or other object may be placed through opening 120 to begin the reversing operation from the second orientation to the first orientation.

In another embodiment, opening 120 is not a physical opening. Instead, opening 120 is an area of case 102 that is non-opaque or otherwise configured such that screen 104 is visible through opening 120.

In another embodiment, the entirety of case 102 is non-opaque. In such a manner, the entirety of screen 104 is visible in any orientation. In such a configuration, it is possible that, in the first orientation, a portion of screen 104 is completely unobstructed, while another portion of screen 104 is partially obscured by input device 106. Another possibility is that screen 104 is configured as a touch screen. Input device 106 is merely an area of screen 104 set aside for user input. In this embodiment, input device 106 may serve to protect screen 104 from damage.

It should be understood that screen 104 is viewable in both the first orientation and the second orientation and that the input device 106 is also usable in both the first orientation and the second orientation. In fact, screen 104 and input device 104 are both operational in any orientation in between the first and second orientation.

With reference to 2F, a connector 132 may be present on reversible unit 110. Connector 132 allows a user to interface media device 100 with another device. For example, media device 100 may connect to a personal computer, which allows a user to transfer files to and from media device 100. Connector 132 may be any type of connector used to interconnect electronic devices, such as a USB port, a Firewire port, or a proprietary connection.

The placement of connector 132 as shown in FIG. 2F serves another important function. In devices of the prior art, a connector is exposed to the elements, which may result in damage to the connector over the lifetime of the device. In contrast, connector 132 is only exposed to the elements in the second orientation. In the first orientation, connector 132 is protected from accidental damage.

With reference to FIGS. 2B-2F, buttons 120, located on case 102, may also be present in an embodiment of the present invention. Buttons 120 allow a user to control media device 100 when the input device 106 is inaccessible (for example, when media device 100 is placed on a desk.

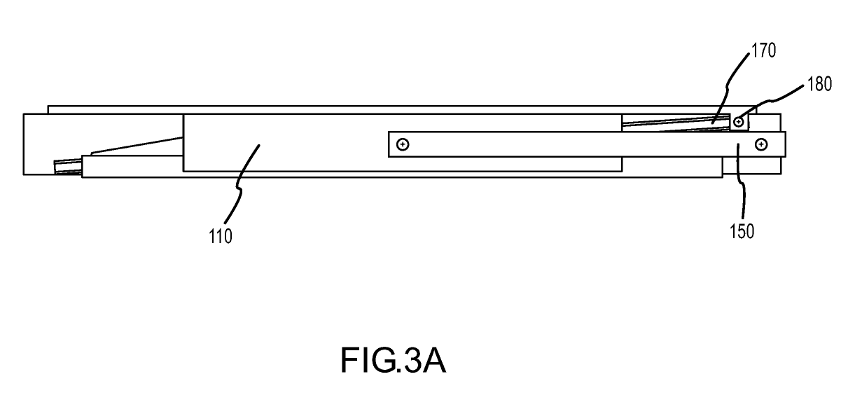

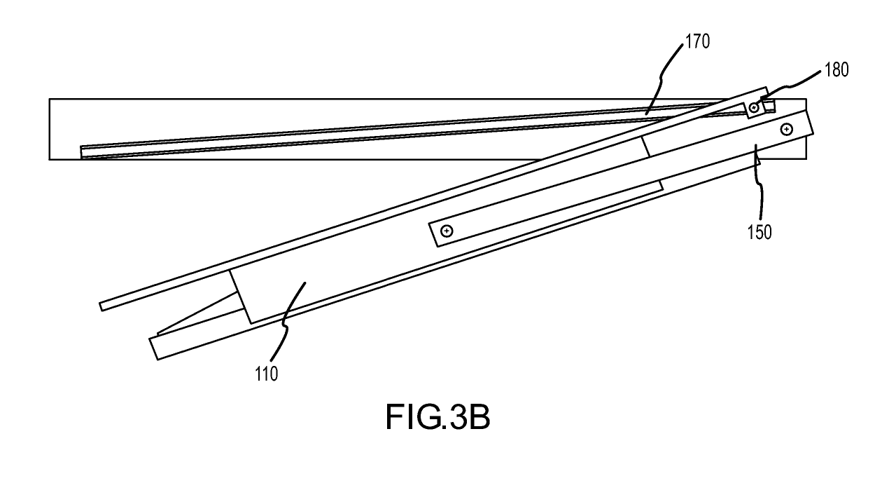

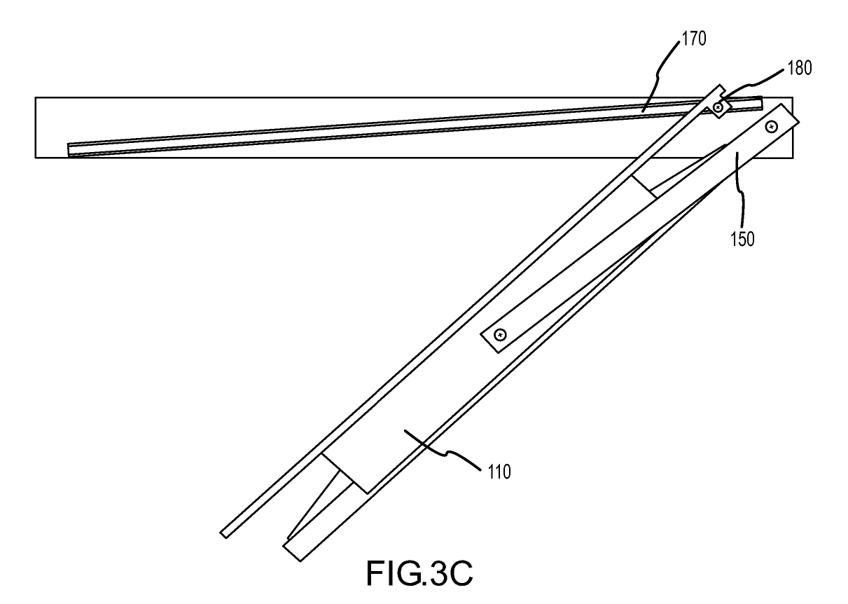

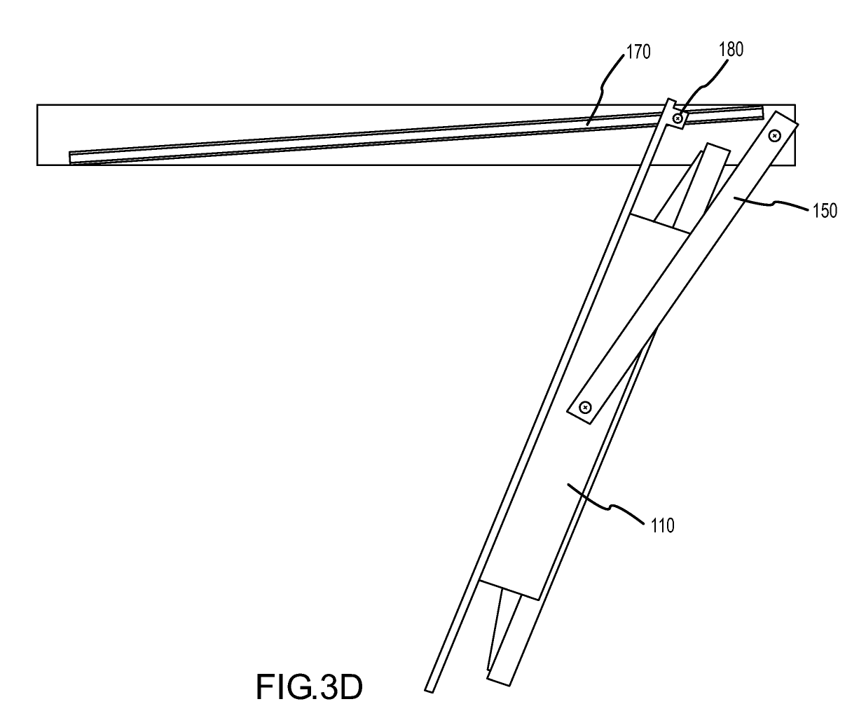

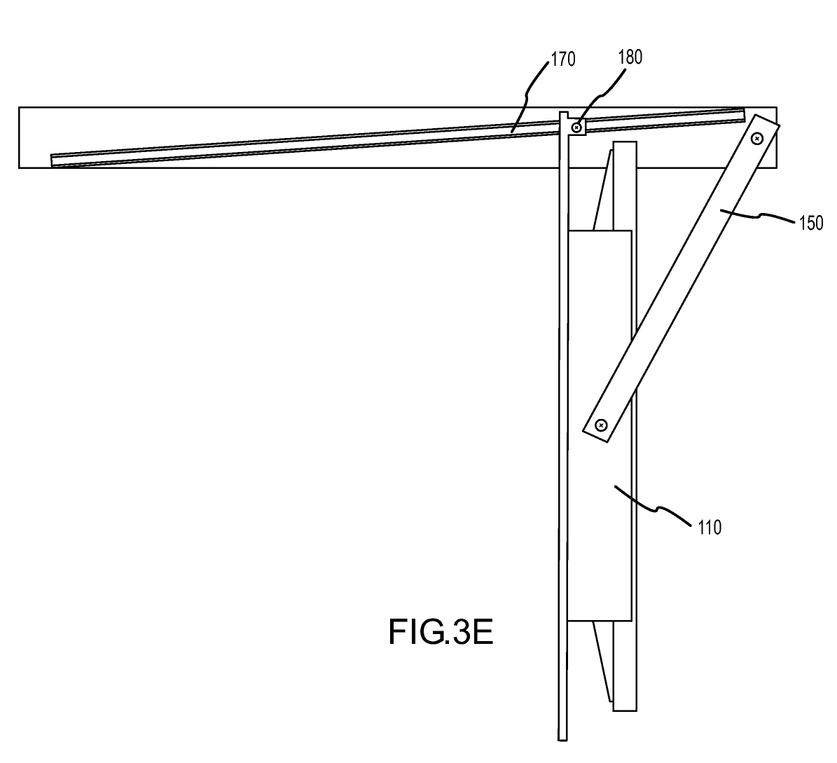

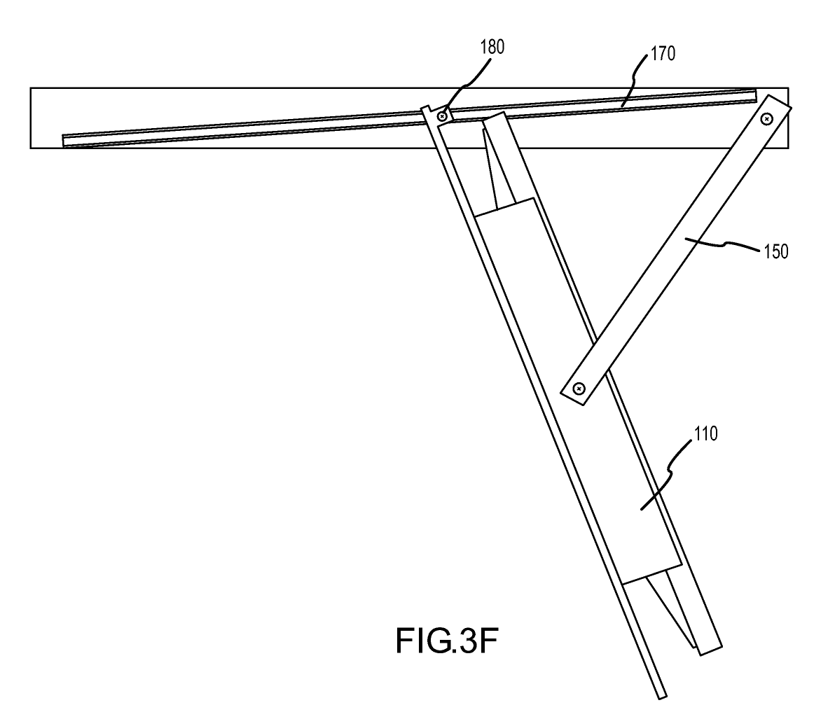

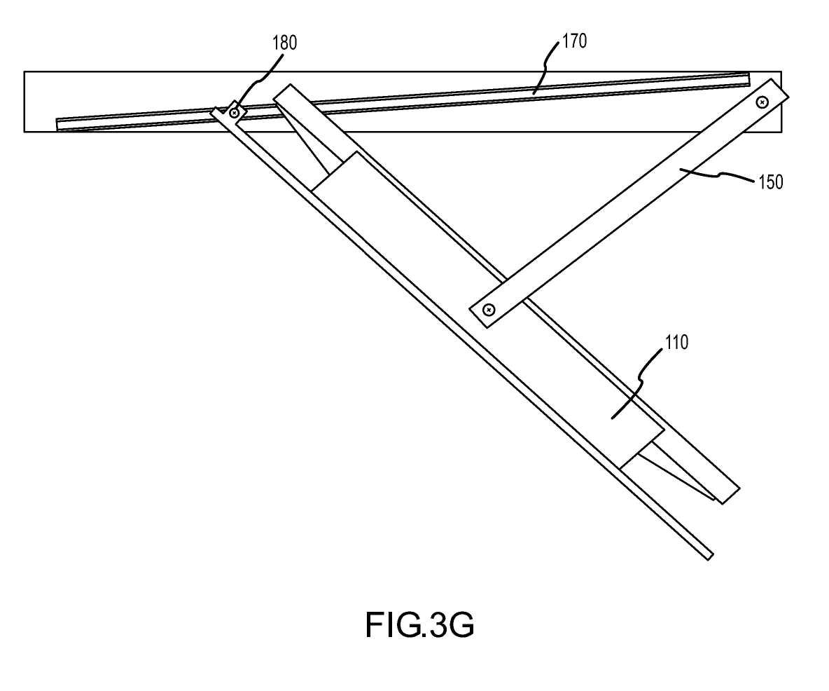

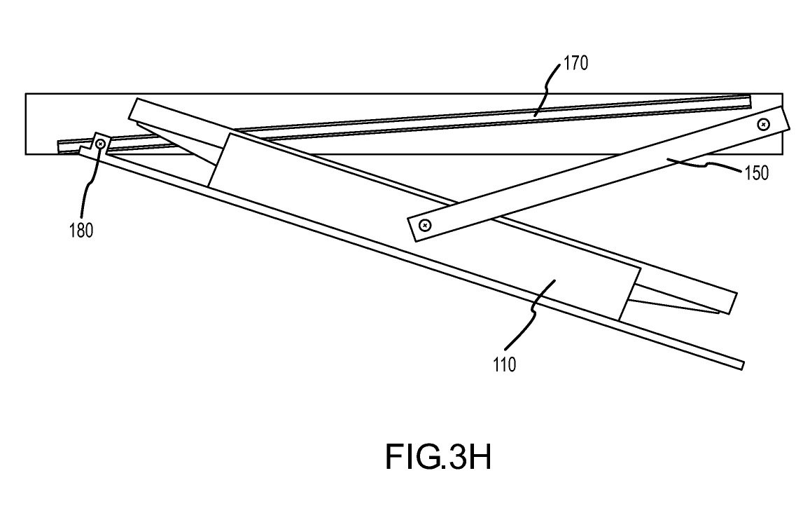

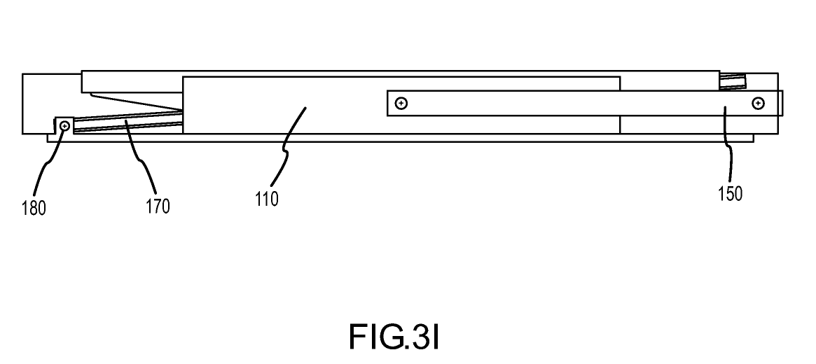

FIG. 3A shows a side view of an embodiment of the present invention to illustrate the mechanism that allows the reversal of reversible unit 110. Arm is coupled to reversible unit 110. At the end of reversible unit 110 is follower 180. The movement of follower 180 is restricted by guide 170, which is located within case 102.

With reference to FIGS. 3A-3I, the movement of reversible unit 110 as it moves from a first orientation to a second orientation is shown, with an emphasis on how the configuration of follower 180, guide 170, and arm 150 result in a 180 degree movement of reversible unit 110. Arm 150 is coupled to reversible unit 110. This coupling may be at any position of reversible unit 110. However, to achieve in a 180 degree rotation within case 110, arm 150 is coupled to reversible unit 110 at a geometric center of reversible unit 110.

As seen in FIGS. 3A-3C, when reversible unit 110 is first moved, the movement of reversible unit 110 is controlled primarily by the arm 150. In essence, the movement of reversible unit is akin to a hinged movement. With reference to FIGS. 3D-3F, as reversible unit 110 is moved further, follower 180 begins moving within guide 170, forcing one end of reversible unit 110 to translate along the path defined by guide 170. With reference to FIGS. 3G-3I, as follower 180 nears the end of the path defined by guide 170, arm 150 allows reversible unit 110 to come to a final position in the second orientation.

Although path 170 is shown as straight in FIGS. 3A-3I, it should be noted that path 170 could be a variety of different shapes. In one embodiment, path 170 is curved, in order to provide additional room for various electronic components within media device 100. Path 170 may also have multiple curves.

Path 170 may also have a detent which allows follower 180 to rest within path 170. For example, it may be desirable to have a third orientation in which screen 104 is tilted in one direction. An example of such an orientation is shown in FIG. 2D. In this third orientation, media device 100 may be placed on a desk and be controllable through buttons 120.

In one embodiment, path 170 is a slot within case 102. Follower 180 is a pin that rests within the slot. It should be understood that path 170 and follower 180 may comprise any type of mechanism in which the movement of follower 180 is restricted by path 170.

There are two arms present in the embodiment shown in FIGS. 2A-2F, one on either side of reversible unit 110. Arm 150 and arm 152 are joined together by torsion bar 154. Torsion bar 154 coordinates the motion of arms 150 and 152, so that the arms move in the same direction at the same time. In one embodiment, torsion bar 154, arm 150, and arm 152 comprise a single assembly. The electrical connection between reversible unit 110 and case 102 is carried within arm 150 and 152.

In another embodiment of the present invention, a portion of case 102, containing input device 106, is removable from case 102. The removed portion is configured to operated media device 100 remotely. This may be accomplished in a variety of different manners. For example, the removed portion may contain a Bluetooth transmitter and case 102 contains a Bluetooth receiver. In such a manner, user inputs to input device 106 are transmitted to media device 100, with the results viewable on screen 104.

In the foregoing specification the invention has been described with reference to specific exemplary embodiments thereof. It will, however, be evident that various modifications and changes may be made thereto without departing from the broader scope of the invention. The specification and drawings are, accordingly, to be regarded in an illustrative rather than restrictive sense. While the present invention has been discussed with respect to a portable media device, it should be understood that media device 100 may be a variety of sizes, from a laptop computer to a tablet computer to a PDA to a flash-based MP3/video player.

What is claimed is:

1. A media device comprising:
a reversible unit including a front side and a back side, said front side comprising a screen;
a case where at least a portion of said case is non-opaque;
a mechanism coupling said reversible unit and said case, said mechanism comprising:
a first arm coupled from said case to said reversible unit;
a guide located in said case; and
a follower coupled to said reversible unit, wherein the movement of said follower is determined by said guide; wherein
said mechanism allows said reversible unit to alternate between a first orientation in which said front side is viewable through said non-opaque portion of said case and a second orientation in which said front side is turned 180 degrees from the first orientation.

2. The media device of claim 1 wherein said screen on said reversible unit is configured to display video at a first size, capable of being viewed through said non-opaque portion of said case in said first orientation; and
said reversible unit is configured to display video at a second size in said second orientation.

3. The media device of claim 2 further comprising:
a sensor to determine if said reversible unit is in said first orientation, wherein said media device controls the area of said reversible unit is used based on data from said sensor.

4. The media device of claim 1 further comprising:
an electrical connector located on said reversible unit.

5. The media device of claim 3 wherein said electrical connector is accessible in said second orientation and covered in said first orientation.

6. The media device of claim 1 further comprising:
user input means located on said case, wherein said user input means are operable regardless of the orientation of said reversible unit.

7. The media device of claim 1 wherein:
said reversible unit is flush with said case in both said first orientation of said reversible unit and said second orientation of said reversible unit.

8. The media device of claim 1 wherein:
said case is recessed such that said reversible unit rests within said case in said first orientation and in said second orientation.

9. The media device of claim 1 wherein:
said guide contains a means that allows said reversible unit to rest at a third orientation between said first and second orientation, where said third orientation allows viewing of said reversible unit.

10. The media device of claim 1 wherein:
said first arm connects with said reversible unit at a geometrical center of said reversible unit.

11. The media device of claim 1 further comprising:
a second arm coupled from said case to said reversible unit at an opposite side of said first arm, such that said first arm is parallel to said second arm.

12. The media device of claim 10 wherein:
said second arm connects with said reversible unit at a geometrical center of said reversible unit.

13. The media device of claim 10 wherein:
said first arm is coupled to said second arm via a torsion bar.

14. The media device of claim 13 wherein said first arm, said second arm, and said torsion bar are rigidly coupled together.

15. The media device of claim 1 wherein said guide is straight.

16. The media device of claim 1 wherein said guide is curved.

17. The media device of claim 1 wherein:
said case contains a removable face plate.

18. The media device of claim 16 wherein said removable face plate is configured to remotely control said media device when removed from said media device.

19. A media device comprising:
a reversible unit including a front side and a back side, said front side comprising a screen;
a case where at least a portion of said case is non-opaque;
means for transmitting audio signals;
means for inputting user commands;
means for preventing inadvertent input of commands; and
a mechanism coupling said reversible unit and said case, said mechanism comprising:
a first arm coupled from said case to said reversible unit;
a guide located in said case; and
a follower coupled to said reversible unit, wherein the movement of said follower is determined by said guide; wherein
said mechanism allows said reversible unit to alternate between a first orientation in which said front side is viewable through said non-opaque portion of said case and a second orientation in which said front side is turned 180 degrees from the first orientation;
said screen displays video signals at a first size in said first orientation and displays video signals at a second size in said second orientation.
said user input means is operable in both said first orientation and said second orientation; and
said screen is operable in both said first orientation and said second orientation.

20. A media device comprising:
a reversible unit including a front side and a back side, said front side comprising a screen;
a case where at least a portion of said case is non-opaque;
a mechanism coupling said reversible unit and said case, configured to allow said reversible unit to alternate between a first orientation in which said front side is viewable through said non-opaque portion of said case and a second orientation in which said front side is turned 180 degrees from the first orientation; and
user input means; wherein
said screen displays video signals at a first size in said first orientation and displays video signals at a second size in said second orientation.
said user input means is operable in both said first orientation and said second orientation; and
said screen is operable in both said first orientation and said second orientation.
